(19) United States
(12) Patent Application Publication
(10) Pub. No.: US 2007/0211224 A1
(43) Pub. Date: Sep. 13, 2007

(54) PROJECTION DEVICE CAPABLE OF DETERMINING WHETHER A LIGHT SOURCE HAS BEEN COOLED DOWN BEFORE A TURN-ON PROCEDURE AND METHOD FOR CONTROLLING A TURN-ON PROCEDURE OF A PROJECTION DEVICE

(76) Inventors: Shun-Chieh Yang, Taipei County (TW); Fu-Shiung Shih, Tai-Chung Hsien (TW); Hung-Jen Wei, Nan-Tou Hsien (TW); Hsin-Nan Lin, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/685,184

(22) Filed: Mar. 12, 2007

(30) Foreign Application Priority Data
Mar. 13, 2006 (TW) 095108397

(51) Int. Cl. G03B 21/20

(52) U.S. Cl. 353/85

(57) ABSTRACT

While turning on a projection device, the projection device determines whether a light source has been cooled down. If so, the projection device directly turns on the light source. Otherwise, the projection device performs a cooling procedure, and then turns on the light source.

### BACKGROUND OF THE INVENTION

1. Field of the Invention

The present invention relates to a method for controlling a projection device, and more specifically, to a method for controlling a turn-on procedure of a projection device.

2. Description of the Prior Art

Use of a projector has rapidly grown in popularity. For example, using a projector to present a report makes information offered by the report clearly understandable to a watching conferee in a conference.

In most cases, during a turn-off procedure, a projector starts a cooling procedure to reduce the temperature of its light bulb down to an appropriate temperature for turning on its light bulb again. Time for executing the said cooling procedure, depending on the type of light bulb, is about 90˜120 seconds. However, a user may shut down the power of the projector directly in unknowing or impatient circumstances to bring about an unfinished cooling procedure. Under this circumstance, if the user then turns on the projector in a short time, like in 30 minutes, the light bulb may fail to light due to insufficient cooling and consequently the light bulb's life is shortened.

### SUMMARY OF THE INVENTION

The present invention provides a method for controlling a turn-on procedure of a projection device having a light source, the method comprising determining whether the light source has been cooled down before the turn-on procedure.

The present invention further provides a projection device capable of determining whether a cooling procedure has been completed before a turn-on procedure, the projection device comprising a light source for supplying light, a cooler for cooling the light source, a first determining means for determining whether the cooling procedure has been completed so as to generate a judgment value after a turn-off procedure, a memory module coupled to the first determining means for storing the judgment value, and a micro control unit coupled to the memory module and the cooler for controlling the cooler to cool the light source according to the judgment value.

The present invention further provides a projection device capable of determining whether a cooling procedure has been completed before a turn-on procedure, the projection device comprising a light source for supplying light, a cooler for cooling the light source, a timer for calculating a turn-off duration of the projection device, a second determining means coupled to the timer for determining whether the turn-off duration is greater than a predetermined value so as to generate a determined result, and a micro control unit coupled to the second determining means and the cooler for controlling the cooler to cool the light source according to the determined result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a projection device according to the present invention.

FIG. 2 is a flowchart of a method for controlling a turn-on procedure of the projection device in FIG. 1.

### DETAILED DESCRIPTION

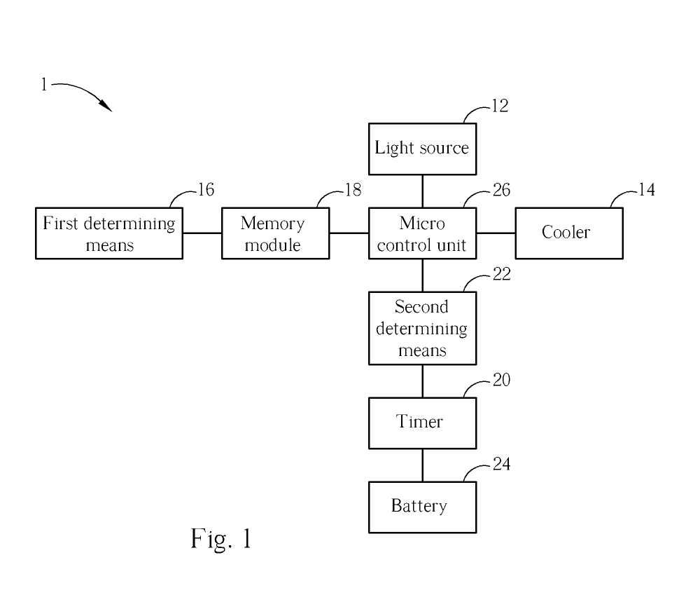

Please refer to FIG. 1. FIG. 1 is a functional block diagram of a projection device 1 according to the present invention. The projection device 1 comprises a light source 12, a cooler 14, a first determining means 16, a memory module 18, a timer 20, a second determining means 22, a battery 24, and a micro control unit 26. The light source 12 is used for supplying light. The cooler 14 is used for cooling the light source 12. The first determining means 16 is used for determining whether a cooling procedure has been completed so as to generate a judgment value after a turn-off procedure. The memory module 18 is coupled to the first determining means 16 for storing the judgment value. The timer 20 is used for calculating a turn-off duration of the projection device 1. The second determining means 22 is coupled to the timer 20 for determining whether the turn-off duration is greater than a predetermined value so as to generate a determined result. The battery 24 is coupled to the timer 20 for supplying electric power to the timer 20. The micro control unit 26 is coupled to the light source 12, the cooler 14, the memory module 18, and the second determining means 22. The micro control unit 26 is used for controlling the cooler 14 to cool the light source 12 according to the judgment value and the determined result.

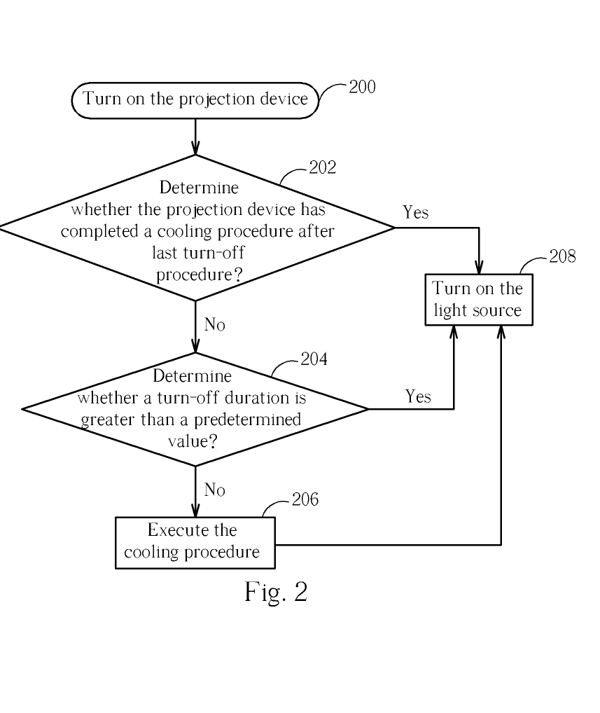

Please refer to FIG. 2. FIG. 2 is a flowchart of a method for controlling a turn-on procedure of the projection device 1 according to the present invention. The method comprises the following steps.

Step 200: turn on the projection device 1.

Step 202: determine whether the projection device 1 has completed a cooling procedure after last turn-off procedure. If so, go to Step 208. If not, go to Step 204.

Step 204: determine whether a turn-off duration calculated from the last turn-off procedure is greater than a predetermined value. If so, go to Step 208. If not, go to Step 206.

Step 206: execute the cooling procedure. When it is done, go to Step 208.

Step 208: turn on the light source 12.

More description for FIG. 2 will be provided as follows. First, whether the projection device 1 has completed the cooling procedure after the last turn-off procedure is determined based on the judgment value stored in the memory module 18. For example, suppose the default value of the judgment value is stored as 0 in the memory module 18. If the first determining means 16 determines that the projection device 1 has completed the cooling procedure after the last turn-off procedure, the judgment value is changed to 1 and is then written into the memory module 18 by the first determining means 16. If not, the judgment value keeps changeless (0).

Next, after the last turn-off procedure, the timer 20 is started at the same time to calculate the turn-off duration of the projection device 1. The turn-off duration is calculated until the projection device 1 is turned on again. Furthermore, the battery 24 individually supplies electric power to the timer 20, so the timer 20 can still work properly even if the power of the projection device 1 has been shut down. Subsequently, while turning on the projection device 1 again, the second determining means 22 determines whether the turn-off duration is greater than the predetermined value mentioned in Step 204. In most cases, the predetermined value is set according to a needed time for sufficient natural cooling of the light source 12, like 30 minutes.

Finally, while turning on the projection device 1 again, if the turn-off duration is not greater than the predetermined value and the judgment value is 0, the micro control unit 26 will control the cooler 14 to cool the light source 12 first. This will ensure reducing the temperature of the light source 12 down to an appropriate temperature for turning on the light source 12 again. On the contrary, if the turn-off duration is greater than the predetermined value or the judgment value is 1, the micro control unit 26 will turn on the light source 12 directly.

In addition, Step 202 and Step 204 are exchangeable in sequence, or executing only one of them is allowed. A method for determining whether the cooling procedure has been completed is also not limited to the aforementioned method.

A primary purpose of the present invention is to determine whether the temperature of the light source 12 has been reduced down to an appropriate temperature for turning on the light source 12 of the projection device 1. Then, according to the determined result, the micro control unit 26 can determine which procedure is executed first: execute a cooling procedure first or turn on the light source 12 directly.

The projection device 1 according to the present invention can be a rear-projection television, a cathode ray tube (CRT) projector, a liquid crystal display (LCD) projector, a digital light processing (DLP) projector, a liquid crystal on silicon (LCOS) projector, and so on. The light source 12 can be a light bulb or another device that can supply light. The cooler 14 can be an electric fan or another cooling device that can cool the light source. The memory module 18 can be a flash memory.

When a user turns on a projector again in a short time after turning off the projector, the light bulb may fail to light due to the insufficient cooling and consequently the light bulb's life is shortened. A situation mentioned above can be avoided by the method for determining whether a cooling procedure has been completed after last turn-off procedure and a turn-off duration of the projector is greater than a needed time for sufficient natural cooling of the light bulb.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a turn-on procedure of a projection device having a light source, the method comprising determining whether the light source has been cooled down before the turn-on procedure.

2. The method of claim 1 further comprising turning on the light source if the light source of the projection device has been cooled down.

3. The method of claim 1 further comprising executing a cooling procedure to cool down the light source if the light source of the projection device has not been cooled down yet.

4. The method of claim 1 further comprising determining whether the projection device has completed a cooling procedure after a turn-off procedure.

5. The method of claim 1 further comprising starting a timer to calculate a turn-off duration of the projection device after a turn-off procedure.

6. The method of claim 5 further comprising determining whether the turn-off duration is greater than a predetermined value.

7. A projection device capable of determining whether a cooling procedure has been completed before a turn-on procedure, the projection device comprising:
a light source for supplying light;
a cooler for cooling the light source;
a first determining means for determining whether the cooling procedure has been completed so as to generate a judgment value after a turn-off procedure;
a memory module coupled to the first determining means for storing the judgment value; and
a micro control unit coupled to the memory module and the cooler for controlling the cooler to cool the light source according to the judgment value.

8. The projection device of claim 7 further comprising a timer for calculating a turn-off duration of the projection device.

9. The projection device of claim 8 further comprising a battery coupled to the timer for supplying electric power to the timer.

10. The projection device of claim 8 further comprising a second determining means coupled to the timer and the micro control unit for determining whether the turn-off duration is greater than a predetermined value so as to generate a determined result.

11. The projection device of claim 10 wherein the micro control unit controls the cooler to cool the light source according to the judgment value and the determined result.

12. The projection device of claim 7, wherein the cooler is an electric fan.

13. The projection device of claim 7, wherein the light source is a light bulb.

14. A projection device capable of determining whether a cooling procedure has been completed before a turn-on procedure, the projection device comprising:
a light source for supplying light;
a cooler for cooling the light source;
a timer for calculating a turn-off duration of the projection device;
a second determining means coupled to the timer for determining whether the turn-off duration is greater than a predetermined value so as to generate a determined result; and
a micro control unit coupled to the second determining means and the cooler for controlling the cooler to cool the light source according to the determined result.

15. The projection device of claim 14 further comprising a first determining means for determining whether a cooling procedure has been completed so as to generate a judgment value after a turn-off procedure.

16. The projection device of claim 15 further comprising a memory module coupled to the first determining means for storing the judgment value.

17. The projection device of claim 14 further comprising a battery coupled to the timer for supplying electric power to the timer.

18. The projection device of claim 15 wherein the micro control unit controls the cooler to cool the light source according to the judgment value and the determined result.

19. The projection device of claim 14, wherein the cooler is an electric fan.

20. The projection device of claim 14, wherein the light source is a light bulb.
